(19) United States
(12) Patent Application Publication
(10) Pub. No.: US 2025/0184271 A1
(43) Pub. Date: Jun. 5, 2025

(54) COMMUNICATION SYSTEM, PLACEMENT CALCULATION APPARATUS, SETTING INPUT APPARATUS, COMMUNICATION METHOD, AND PROGRAM

(71) Applicant: NIPPON TELEGRAPH AND TELEPHONE CORPORATION, Tokyo (JP)

(72) Inventors: Yukihiro TOGARI, Tokyo (JP); Shingo OKADA, Tokyo (JP); Hisashi KOJIMA, Tokyo (JP); Takafumi HAMANO, Tokyo (JP)

(21) Appl. No.: 18/841,554

(22) PCT Filed: Mar. 2, 2022
(86) PCT No.: PCT/JP2022/008933

§ 371 Date: Aug. 26, 2024

(51) Int. Cl. H04L 45/76; H04L 12/66; H04L 47/24

(52) U.S. Cl. CPC H04L 45/76; H04L 12/66; H04L 47/24

(57) ABSTRACT

A communication system includes: a first host that includes a gateway configured to perform network processing on a packet transmitted from a device, attaches a first mark indicating that a forwarding source is the gateway to the packet forwarded from the gateway, and forwards the packet with the first mark attached; and a second host that includes an application, receives the packet forwarded from the first host, marks the received packet with a second mark indicating that the forwarding source is the first host, forwards the packet with the second mark attached, to the application, and forwards the packet forwarded from the application to the first host on the basis of the second mark, in which the first host forwards the packet received from the second host to the gateway on the basis of the first mark.

### TECHNICAL FIELD

The present invention relates to a packet routing scheme in a communication system.

### BACKGROUND ART

A communication form in which a communication apparatus such as a gateway (GW) and an application are combined on a virtualization infrastructure to provide a service has been widely spread.

When an application is used from a device (terminal) of a user via a GW, it is sometimes necessary to send back a processing result or the like of the application to the source device. As a conventional technique for this purpose, a method is known in which an interior gateway protocol (IGP) or an agent instance (Non Patent Literature 1) is introduced to cause a host to learn a route necessary for GW identification.

As another conventional technique, there is also known a method in which an application configured to process a packet identifies a packet-forwarding source GW by performing source network address translation (SNAT) (Non Patent Literature 2) with the address of the GW.

### CITATION LIST

### Non Patent Literature

Non Patent Literature 1: Calico Felix: https://projectcalico.docs.tigera.io/maintenance/monitor/mo nitor-component-metrics
Non Patent Literature 2: BIG IP SNAT: https://www.f5.com/ja_jp/services/resources/glossary/secure-network-address-translation-snat

### SUMMARY OF INVENTION

### Technical Problem

However, in the above-mentioned conventional techniques, there have been problems such as disconnection of a session when a terminal reconnects to a different GW, and necessity to cause a host to learn a large number of routes.

The present invention has been made in view of the above points, and an object of the present invention is to provide a technique for forwarding a packet processed by an application to an appropriate GW in which the technique can ensure that a session is not to be disconnected even at the time of reconnection to the GW from a terminal and learning of a large number of routes is not required.

### Solution to Problem

According to the disclosed technique, there is provided a communication system including:
a first host that includes a gateway configured to perform network processing on a packet transmitted from a device, attaches a first mark indicating that a forwarding source is the gateway to the packet forwarded from the gateway, and forwards the packet with the first mark attached; and
a second host that includes an application, receives the packet forwarded from the first host, marks the received packet with a second mark indicating that the forwarding source is the first host, forwards the packet with the second mark attached, to the application, and forwards the packet forwarded from the application to the first host on the basis of the second mark, in which
the first host forwards the packet received from the second host to the gateway on the basis of the first mark.

### Advantageous Effects of Invention

According to the disclosed technique, there is provided a technique for forwarding a packet processed by an application to an appropriate GW in which the technique can ensure that a session is not to be disconnected even at the time of reconnection to the GW from a terminal and learning of a large number of routes is not required.

### BRIEF DESCRIPTION OF DRAWINGS

FIG. 1 is a diagram for explaining a premise of a service.

FIG. 2 is a diagram for explaining a network as a service infrastructure.

FIG. 3 is a diagram for explaining a conventional technique.

FIG. 4 is a diagram for explaining a conventional technique.

FIG. 5 is a diagram illustrating a summary of the conventional techniques.

FIG. 6 is a diagram for explaining an outline of a proposed scheme.

FIG. 7 is a diagram for explaining an outline of the proposed scheme.

FIG. 8 is a diagram for explaining a first proposal.

FIG. 9 is a diagram for explaining a second proposal.

FIG. 10 is a diagram for explaining the second proposal.

FIG. 11 is a diagram for explaining a third proposal.

FIG. 12 is a diagram for explaining the third proposal.

FIG. 13 is a diagram for explaining the third proposal.

FIG. 14 is a diagram for explaining a processing flow in a routing scheme of the present embodiment.

FIG. 15 is a diagram illustrating an example in the case of a virtual machine (VM)-container-nested structure.

FIG. 16 is a diagram illustrating a processing flow of instance arrangement determination.

FIG. 17 is a diagram illustrating a processing flow of setting automation.

FIG. 18 is a diagram illustrating an overall configuration example of a system according to an embodiment of the present invention.

FIG. 19 is a configuration diagram of a host management unit.

FIG. 20 is an example of a host information database (DB).

FIG. 21 is a configuration diagram of an instance management unit.

FIG. 22 is an example of an instance information DB.

FIG. 23 is a configuration diagram of an arrangement calculation unit.

FIG. 24 is a configuration diagram of a setting feeding unit 400.

FIG. 25 is a diagram illustrating an example of each table.

FIG. 26 is a sequence of instance arrangement at the time of starting a service.

FIG. 27 is a diagram illustrating a packet flow.

FIG. 28 is a diagram illustrating a hardware configuration example of an apparatus.

### DESCRIPTION OF EMBODIMENTS

An embodiment of the present invention (the present embodiment) will be described below with reference to the drawings. The embodiment to be described below is merely exemplary, and embodiments to which the present invention is applied are not limited to the following embodiment.

### (About Premise of Service)

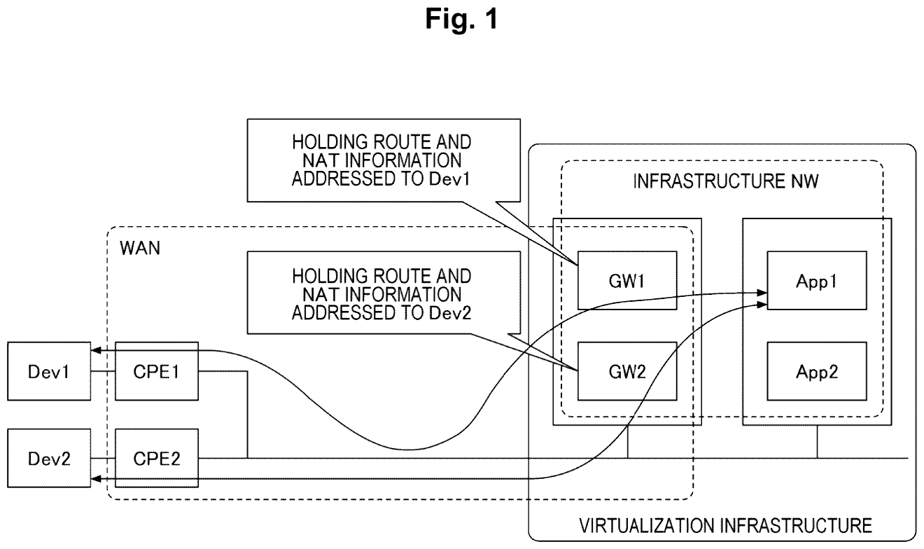

First, a system that provides a service assumed in the present embodiment will be described with reference to FIG. 1.

As illustrated in FIG. 1, the present system includes a gateway (GW), an application (APP), and a device (Dev) connected to customer premises equipment (CPE).

Here, the GW carries out network processing (example: tunneling, load balancing) necessary for the service. The App is an endpoint (example: machine learning, image processing, storage) that is equipped with service logic. For communication establishment, it is assumed that communication establishment is carried out in a direction from the Dev to the GW and App that provide the service.

In the present embodiment, it is assumed that the GW and the App operate in the form of a VM or a container on a virtualization infrastructure. There is a plurality of instances as GWs, and routes addressed to a wide area network (WAN) are held in a balanced manner, whereby load balancing is performed in the network processing. There is a plurality of instances as Apps, and processing loads of the Apps are balanced. Note that a single GW or App may be prepared separately.

In the example in FIG. 1, a GW 1, a GW 2, an App 1, an App 2, CPE 1, CPE 2, a Dev 1, and a Dev 2 are illustrated. As illustrated in FIG. 1, the GW 1 holds a route and network address translation (NAT) information addressed to the Dev 1, and the GW 2 holds a route and NAT information addressed to the Dev 2.

Next, a premise of a service infrastructure network (infrastructure NW) will be described. The infrastructure NW has different network (NW) segments (for example, implemented by Calico, Cillium, Openstack, and the like.) between instances. The instances do not have its individual routes, and communication between the instances is relayed by a host or a network node. Routing requirements of the service assumed in the present embodiment are as follows. Note that the “host” in the present embodiment may be a physical server or may be a virtual server.

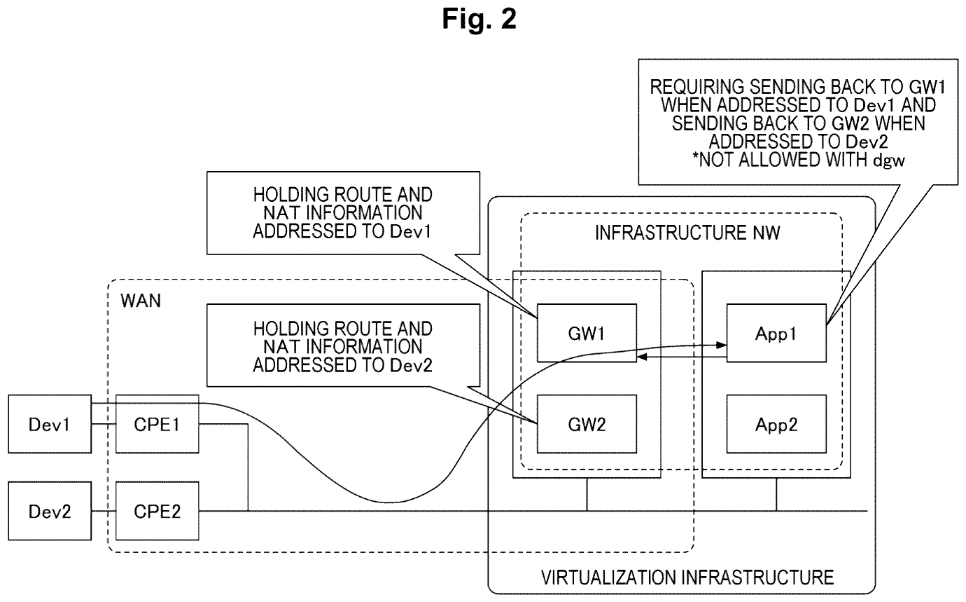

The GW holds network processing information such as a forwarding route and the NAT information, and a packet processed by the App needs to be forwarded to the GW having appropriate network processing information. As illustrated in FIG. 2, for example, the App 1 needs to forward a packet addressed to the Dev 1 to the GW 1 and send back a packet addressed to the Dev 2 to the GW 2. A default gateway (dgw) is not allowed to perform such forwarding processing.

### Conventional Techniques

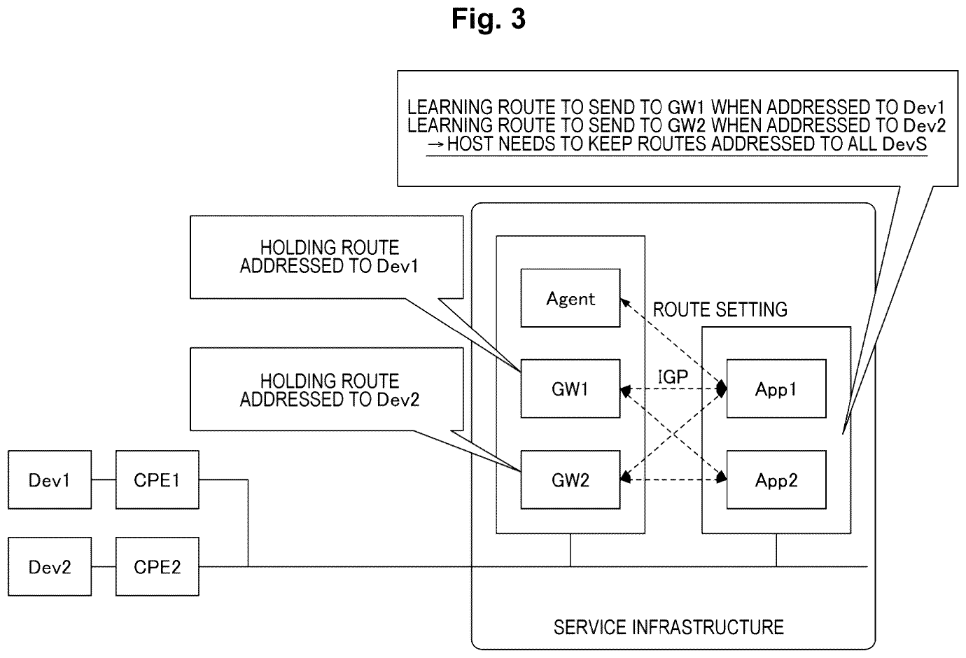

As a conventional technique for forwarding a packet processed by the App to the GW having appropriate network processing information, there is a technique of introducing an IGP or an agent instance (Non Patent Literature 1) and causing a host to learn a route necessary for GW identification. FIG. 3 illustrates that an agent instance on a host 1 performs route setting for Apps.

However, in this conventional technique, learning of routes (corresponding to the number of pieces of CPE) is required for a large number of hosts, and there is a problem that scalability, resources, and trackability are affected. In addition, there is also a problem that the operation cost for newly preparing the IGP and an additional agent instance is incurred.

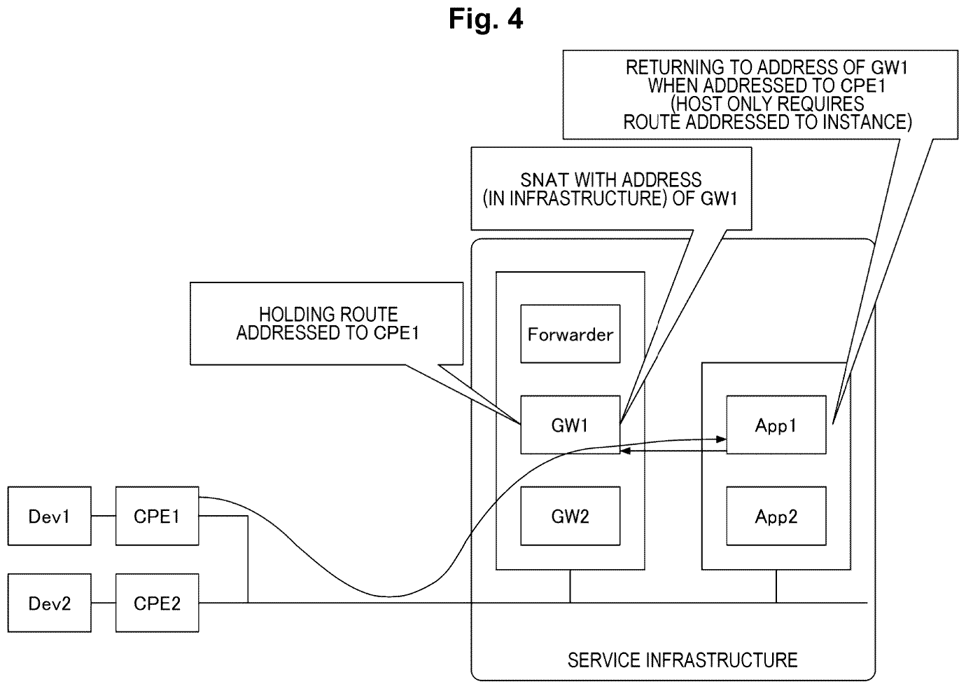

There is also a conventional technique using SNAT. In this conventional technique, as illustrated in FIG. 4, SNAT is performed on an inflow packet into a GW with the address of the GW instance, whereby an App configured to process the packet identifies the transmission source GW (Non Patent Literature 2).

However, there is a case where a packet originating from CPE reconnects to a different GW, such as a case where the CPE moves. At this time, since the transmission source Internet protocol (IP) appears to be changed from the viewpoint of the App, the session is no longer allowed to be maintained. In the example in FIG. 4, for example, when a packet originating from the CPE 1 is connected to the GW 2, the session is no longer allowed to be maintained.

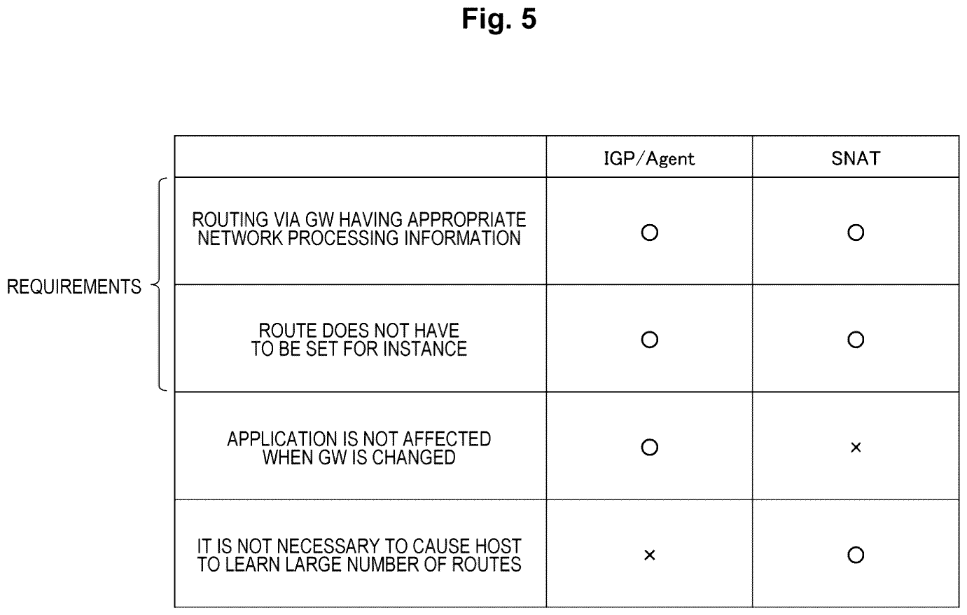

FIG. 5 illustrates a summary of the conventional techniques. As illustrated in FIG. 5, the conventional techniques have the following two disadvantages, and a routing scheme capable of solving these disadvantages is required.
The application processing is affected even when, for example, the terminal connects to a different GW.
It is necessary to cause a host to learn a large number of routes

### Outline of Proposed Scheme

An outline of a proposed scheme in the present embodiment for solving the above problems will be described. In the present embodiment, by focusing on a service that establishes communication in a direction from a device to a service (GW and App), policy-based routing (PBR) is performed so as to return egress traffic to a packet-inflow source GW or a host server of the GW in stages.

Specifically, the above is implemented by Connmark (a function of attaching a mark to a tracked flow) in the host and the PBR based on the mark.

In addition, as a contrivance for arrangement optimization in order to reduce the number of flows to be subjected to Connmark and PBR, instances may be arranged such that processing is completed by a pair of GW and App in a single host.

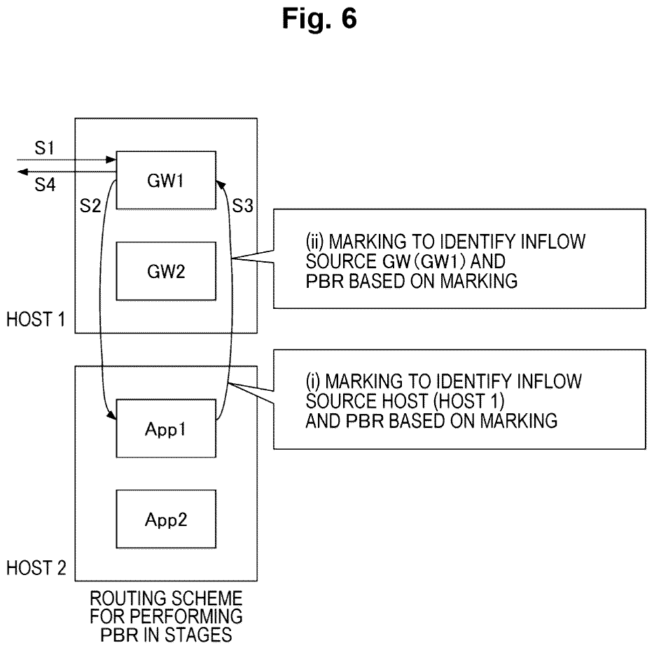

An example of a basic configuration (a routing scheme that performs the PBR in stages) will be described with reference to FIG. 6. A host 1 includes a GW 1 and a GW 2, and a host 2 includes an App 1 and an App 2. The GW 1 receives a packet in S1 and forwards the packet to the App 1 in S2. In S3, in (i), the host 2 assigns a mark that identifies the traffic-inflow source host (host 1) and performs the PBR based on the assigned mark. In (ii), the host 1 assigns a mark that identifies the inflow source GW (GW 1) and performs the PBR based on the assigned mark.

That is, in (i), the host 2 performs PBR that returns the packet to the inflow source host 1, and in (ii), the host 1 performs PBR that returns the packet to the inflow source GW 1.

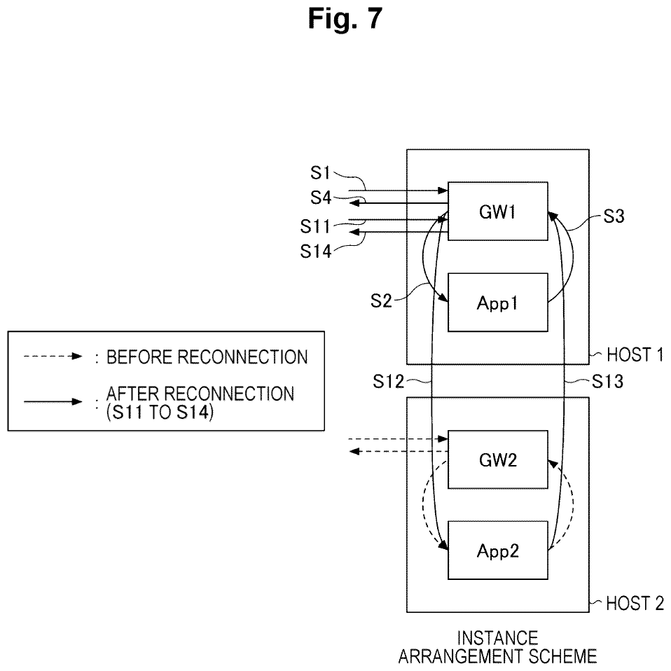

A contrivance in arrangement (instance arrangement scheme) will be described with reference to FIG. 7. As illustrated in FIG. 7, the GW 1 and the App 1 are arranged in the host 1, and the GW 2 and the App 2 are arranged in the host 2. That is, a single GW is prepared in each host. This enables to reduce connection tracking or PBR ((i) of FIG. 6) setting for distinguishing a GW in the host as illustrated in (ii) of FIG. 6.

As in the flow from S1 to S4 in FIG. 7, the processing can be basically completed by the host 1. As in the flow from S11 to S14, connection tracking and PBR ((i) of FIG. 6) for identifying the inflow source flow is performed only for a flow in which processing is not allowed to be completed by a single host due to a flow with reconnection to a different GW or a difficulty in a resource, and performance degradation is suppressed. Hereinafter, each of first to third proposals that are proposed contents according to the present embodiment will be described.

### (First Proposal: Minimum Configuration)

A minimum configuration of the system according to the present embodiment will be described as the first proposal. In the system according to the present embodiment, by focusing on a service that establishes communication in a direction from a device to a GW and an App, ingress traffic is processed by an appropriate GW, and policy-based routing (PBR) that returns egress traffic to the inflow source GW or a host server of the GW is performed.

Specifically, connmark and PBR based on a mark is set in stages. With this setting, it is not necessary to rewrite the packet header, and thus the session is not disconnected when the GW is changed. In other words, the application processing is not affected.

In addition, in the present system, the processing of Connmark is dynamically performed for the flow, and the number of settings for the processing is in units of hosts or in units of GWs. This achieves less settings as compared with the conventional schemes that require settings in units of Devs.

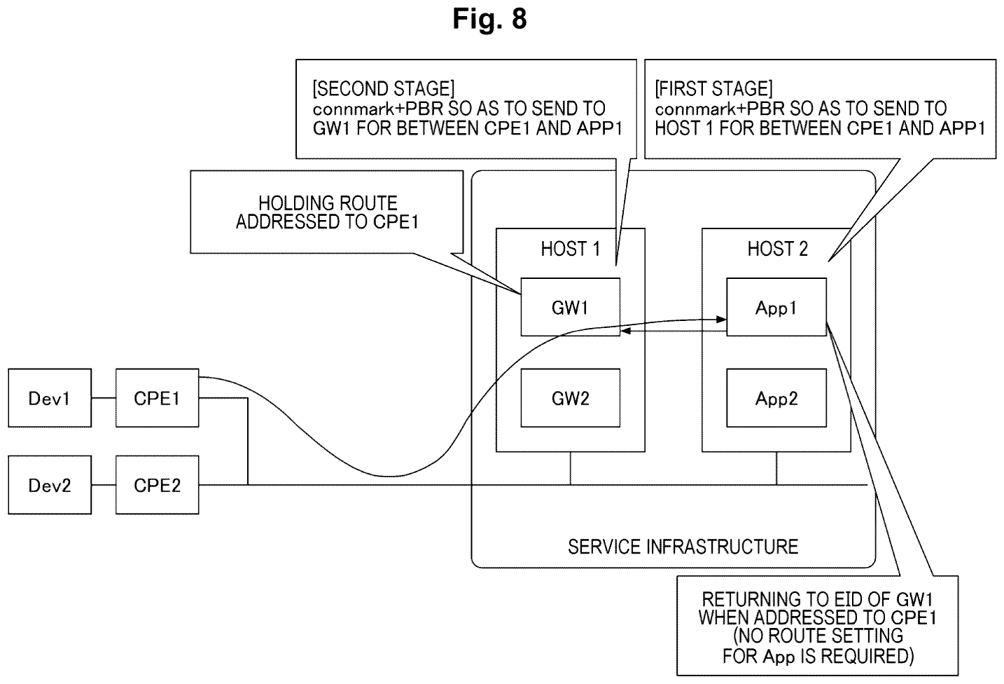

FIG. 8 illustrates an example of a case where traffic from the CPE 1 is processed in a system including the host 1 and the host 2. As illustrated in FIG. 8, the GW 1 holds a route addressed to the CPE 1. As a first-stage setting, in the host 2, when the packet of the communication between the CPE 1 and the App 1 is returned to the CPE 1, connmark+PBR is set so as to send the packet to the host 1. In addition, in the App 1, the traffic addressed to the CPE 1 is returned to the endpoint identifier (EID) of the GW 1.

As a second-stage setting, in the host 1, connmark+PBR is set such that the packet of the communication between the CPE 1 and the App 1 is sent to the GW 1.

### (Second Proposal: Arrangement Optimization)

As described above, in the present embodiment, the instance arrangement is optimized, and the processing and setting of Connmark and PBR are further aggregated.

In other words, by preparing a single GW in the host as long as feasible, the connmark settings for use in GW identification are reduced. In addition, by arranging a number of Apps as equally as possible for each host such that the processing of the GW and the App can be completed in a single host, the number of flows to be subjected to connmark and PBR for use in host identification, and the forwarding delay are reduced.

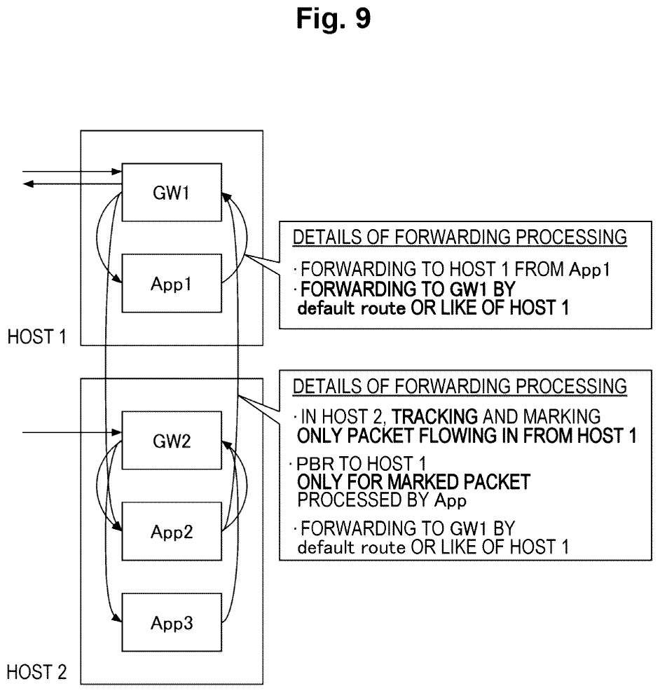

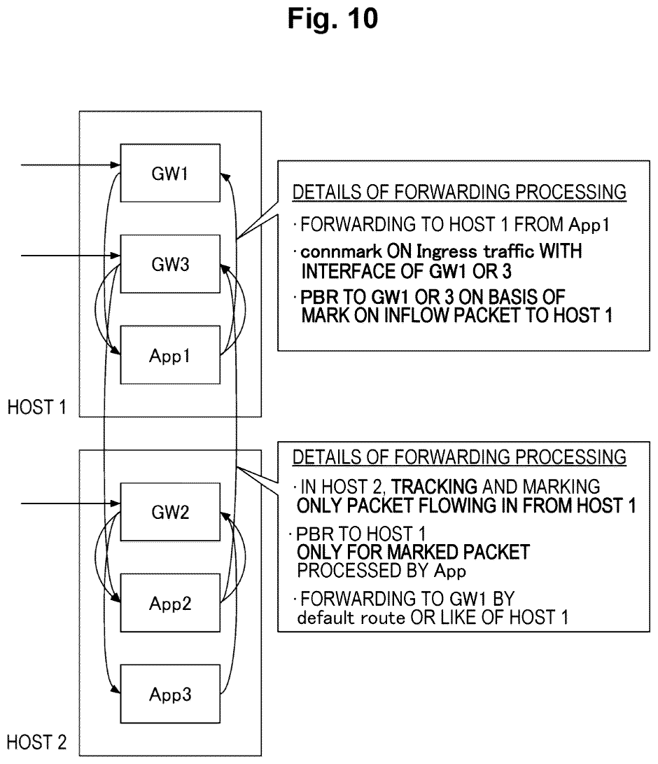

FIG. 9 illustrates a case where the number of GWs in each host is one (example: initial service), and FIG. 10 illustrates a case where the number of GWs for each host has a plurality of GWs (example: peak time).

In the case illustrated in FIG. 9, ingress traffic to the GW 1 is basically preferentially processed by the App 1 in the same host 1. This makes the PBR unnecessary and enables to forward traffic to the host 1 from the App 1 and forward the traffic to the GW 1 by the default route or the like of the host 1, which can reduce settings.

In addition, since the hosts 1 and 2 perform the PBR by tracking only connections across the hosts, the number of connections to be tracked and the number of flows targeted for PBR can be reduced. For example, the host 2 tracks and marks only a packet flowing in from the host 1. In addition, only the marked packet processed by the App can be routed to the host 1 by PBR and forwarded to the GW 1 by a default route or the like of the host 1.

In the example in FIG. 10, as described earlier, connmark and PBR for identifying a GW in the host 1 is required.

As illustrated in FIG. 10, in the host 1, ingress traffic undergoes connmark on the interface of the GW 1 or 3, and the packet is routed to the GW 1 or 3 by PBR on the basis of the mark on the inflow packet to the host 1.

The host 2 tracks and marks only the packet flowing in from the host 1, routes only the marked packet processed by the App to the host 1 by PBR, and forwards the packet to the GW 1 by the default route or the like of the host 1.

### (Third Proposal: Scheme Setting Automation System)

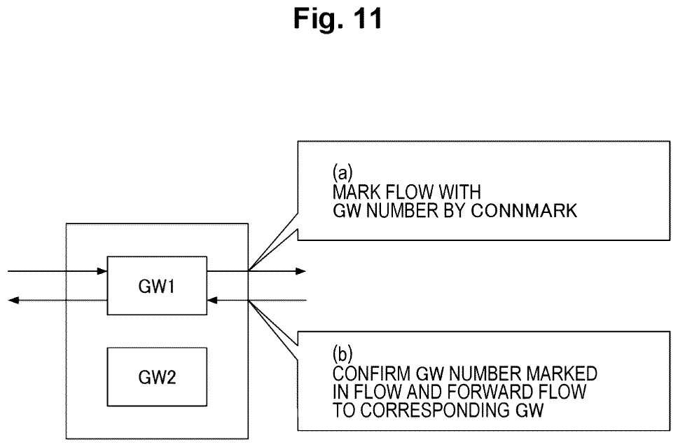

In the third proposal, by adopting a system that automatically makes the above-described scheme settings on the basis of the use situation of the host, settings are made by following an increase or decrease in instances, and stable communication is enabled. A configuration example, setting timing, and setting contents for the host for each use situation will be described with reference to FIGS. 11 to 13.

<Case 1: Case where Plurality of GWs Operate in Host>

A configuration example of a case 1 is illustrated in FIG. 11. The setting timing in the case 1 is at the time of GW activation or deletion, and the setting contents are (a) Connmark settings for the inflow flow (by a number equal to the number of GWs) and (b) PBR settings for forwarding to the GW corresponding to the mark value of the return flow (by a number equal to the number of GWs). Note that, in the case 1, the settings (a) and (b) are unnecessary in a case where there is one GW instance.

<Case 2: Case where App Operates in Host>

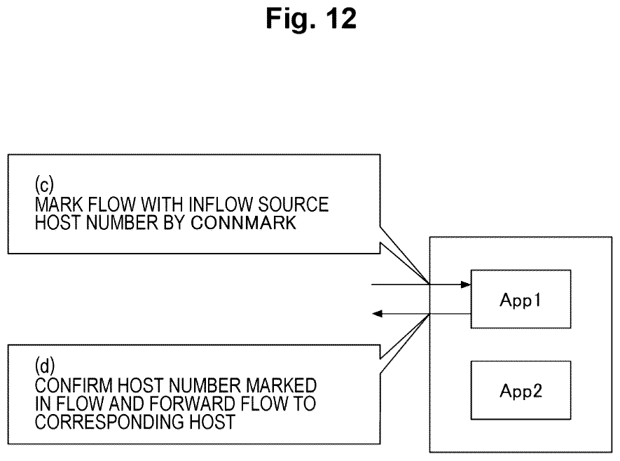

A configuration example of a case 2 is illustrated in FIG. 12. The setting timing in the case 2 is at the time of App activation or deletion, and the setting contents are (c) Connmark settings for the inflow flow (by a number equal to the number of hosts) and (d) PBR settings for forwarding to the GW corresponding to the mark value of the return flow (by a number equal to the number of hosts).

<Case 3: Case where Plurality of GWs and App Operate in Host>

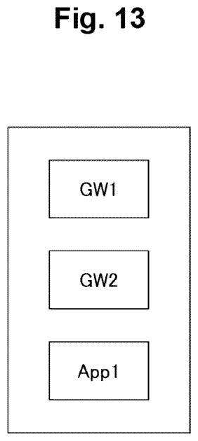

A configuration example of a case 3 is illustrated in FIG. 13. The setting timing in the case 3 is at the time of activation or deletion of the App and the GW, and the setting contents are (a) to (d) described in the cases 1 and 2. Hereinafter, the contents relating to the first to third proposals described above will be described in more detail.

### (Processing Flow in Routing Scheme of First Proposal)

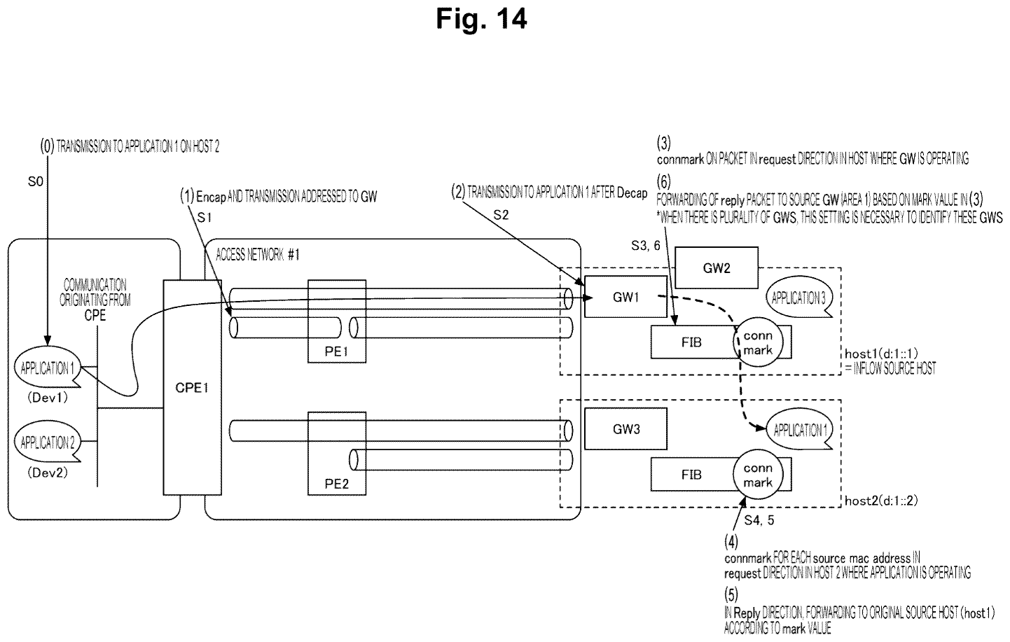

A processing flow in the routing scheme of the first proposal will be described with reference to FIG. 14. In this processing flow, a reply from the application is addressed and sent back to the inflow source GW. Specific processing will be described with reference to FIG. 14.

In S0, the Dev 1 transmits a packet to be transferred to an application 1 on the host 2. In S1, the CPE 1 performs Encap on the packet and transmits the packet addressed to the GW 1. In S2, the GW 1 receives the packet and transmits the packet to the application 1 after Decap.

In S3, the host 1 performs connmark on the packet in a request direction. In S4, connmark is performed for each source media access control (mac) address in the request direction in the host 2 on which the application 1 operates. That is, connmark with the source mac address as a trigger is performed on the host 2 on which the application 1 operates. Note that using the source mac address as a trigger for connmark is an example. Any information may be used as long as the information is included in the packet and can specify the inflow source host. For example, the transmission source IP address in a tunneling header, or the like may be used.

In S5, the packet is forwarded to the inflow source host 1 (on which the GW 1 operates). That is, in a reply direction, the packet is forwarded to the packet-inflow source host 1 according to the mark value.

In S6, the host 1 forwards the reply packet to the inflow source GW 1 on the basis of the mark value in S3. Note that, in this example, since there is a plurality of GWs in the host 1, this setting is necessary to identify these GWs.

### (About Nested Structure)

The system of the present embodiment can also be carried out in a VM-container-nested structure. However, in the nested structure, since the route to the instance (container) is not advertised in the physical server segment, communication is carried out using tunneling such as IP over IP (IPIP).

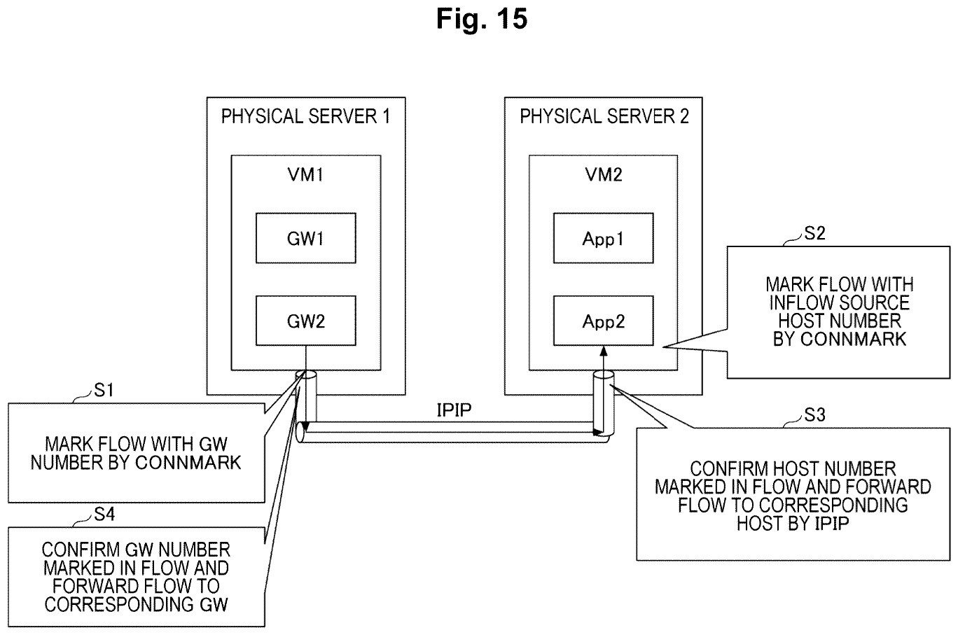

A configuration example adopting the VM-container-nested structure is illustrated in FIG. 15. As illustrated in FIG. 15, communication is established by performing the procedure from S1 to S4 in the VMs 1 and 2 accommodating the instances. No setting for the physical server is required. Details are as follows.

In S1, the VM 1 marks the flow with the GW number by CONNMARK. In S2, the VM 2 marks the flow with the inflow source host number by CONNMARK. In S3, the VM 2 confirms the host number marked in the flow and forwards the flow to the corresponding host by IPIP. In S4, the VM 1 confirms the GW number marked in the flow and forwards the flow to the corresponding GW.

### (Processing Flow of Arrangement Determination Scheme)

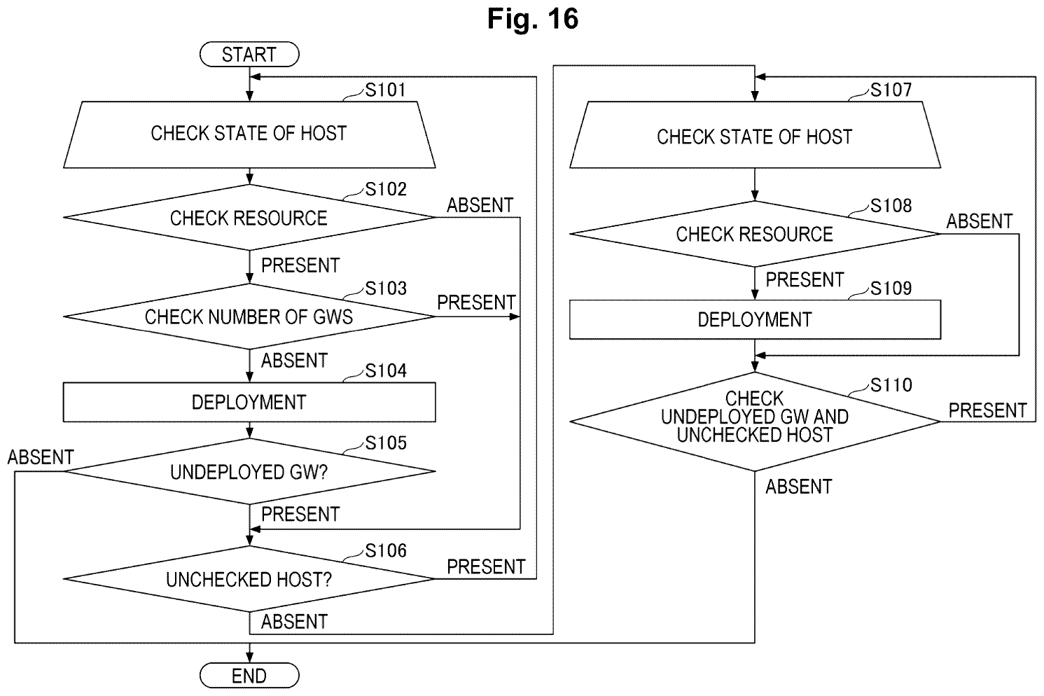

Regarding the arrangement optimization of the second proposal (FIGS. 9 and 10), an example of a processing flow for determining the arrangement of a GW (an example of the instance) for each host included in the system will be described with reference to FIG. 16. The arrangement determination process is executed by an arrangement calculation unit 300 to be described later. However, the deployment is performed by an instance management unit 200. Here, it is supposed that the number of hosts and the number of GWs intended to be deployed are given in advance.

In S101 to S106, one GW is deployed to each host. When not all the GWs are allowed to be deployed even after the above, an additional GW is deployed to the host in S107 to S110. Since both of S101 to S106 and S107 to S110 are repeated for hosts, as an example, each step will be described here for a “host A”.

In S101, the arrangement calculation unit 300 checks the state of the host A. Checking the state means acquiring information necessary for determining the arrangement. In S102, the arrangement calculation unit 300 checks the presence or absence of a resource of the host A and, when there is a resource for the GW deployment, the arrangement calculation unit 300 proceeds to S103 and, when there is no resource, proceeds to S106.

In S103, the arrangement calculation unit 300 checks the number of GWs of the host A, and when there is a GW, the arrangement calculation unit 300 proceeds to S106, and when there is no GW, proceeds to S104.

In S104, the GW is deployed to the host A. In S105 and S106, if there is no undeployed GW, the process ends, and if there is an undeployed GW and there is an unchecked host, the process returns to S101, and the process for the next host is performed.

When there is an undeployed GW and there is no unchecked host, the state of the host A is checked in S107, and a resource of the host A is checked in S108. If there is a resource, the GW is deployed to the host A in S109. If there is no resource, the process proceeds to S110.

In S110, if there are an undeployed GW and an unchecked host, the processes in S108 and S109 are performed for another host.

### (Processing Flow of Setting Automation System)

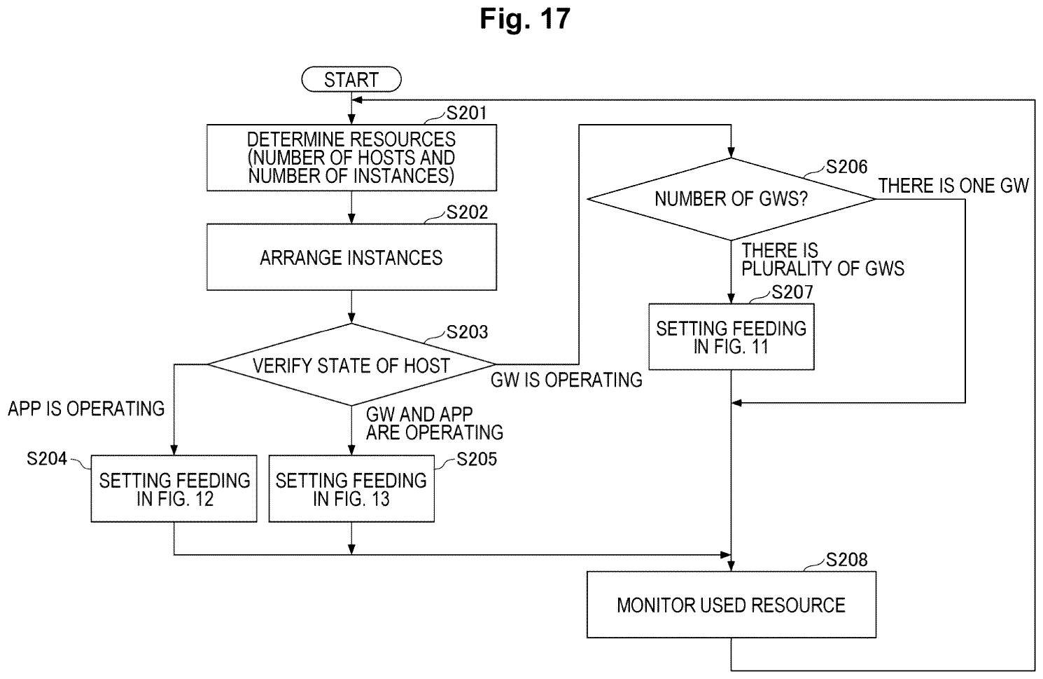

A processing flow of the setting automation of the third proposal (FIGS. 11 to 13) will be described with reference to FIG. 17. The processing here is performed by the instance management unit 200, a setting feeding unit 400, and the like to be described later.

In S201, the instance management unit 200 determines the number of hosts and the number of instances as resources. In S202, the instance management unit 200 (or the arrangement calculation unit 300) arranges the instances. Here, a single GW is prepared as long as feasible, and additionally, the number of applications per host is equalized.

In S203, the setting feeding unit 400 verifies the state of the host on the basis of information from a host management unit 100, and when the App is operating, the setting feeding unit 400 proceeds to S204, when the GW and the APP are operating, proceeds to S205, and when only the GW is operating, proceeds to S206.

The setting feeding unit 400 performs the setting feeding in FIG. 12 in S204 and performs the setting feeding in FIG. 13 in S205.

In S206, if the number of GWs is one, the process proceeds to S208. If the number of GWs has a plurality of GWs, the setting feeding in FIG. 11 is performed in S207. In S208, the instance management unit 200 monitors the used resource.

### Overall System Configuration

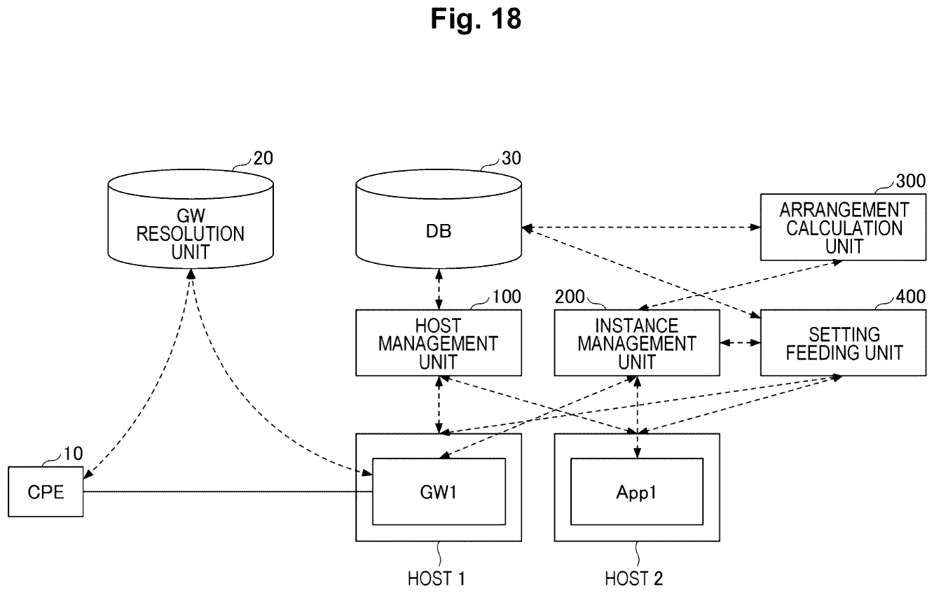

FIG. 18 illustrates an overall configuration example of the system according to the present embodiment. As illustrated in FIG. 18, the present system includes CPE 10, a GW resolution unit 20, a host 1 (host server) on which the GW 1 operates, a host 2 on which the App 1 operates, the host management unit 100, a DB 30, the instance management unit 200, the arrangement calculation unit 300, and the setting feeding unit 400.

Each unit illustrated in FIG. 18 may be an independent apparatus, or a plurality of parts may constitute one apparatus. The GW resolution unit 20, the host management unit 100, the instance management unit 200, the arrangement calculation unit 300, and the setting feeding unit 400 may be referred to as a GW resolution apparatus 20, a host management apparatus 100, an instance management apparatus 200, an arrangement calculation apparatus 300, and a setting feeding apparatus 400, respectively. The outline of each unit (each apparatus) is as follows.

The CPE 10 is a NW apparatus that accommodates client terminals (devices). The CPE 10 inquires of the GW resolution unit 20, thereby determining the connection destination GW.

In a virtual infrastructure on a cloud, the GW 1 that is an instance operating as a NW function for the service, and the App 1 that provides application logic operate on the hosts 1 and 2, respectively.

The host management unit 100 manages the host names and network information and resource information on these hosts with the DB 30. The arrangement calculation unit 300 determines a host on which the instance is to be arranged, on the basis of the number of hosts and its resource status.

The instance management unit 200 arranges the instance on the basis of the determination of the arrangement calculation unit 300 and manages the ID and the network information and resource information on the instance. The setting feeding unit 400 makes network settings for each host on the basis of the instance arrangement status.

Hereinafter, the configuration and operation of each unit will be described in more detail. Note that the configuration and operation of each unit to be described below are an example. The configuration and operation of the apparatuses (parts) may be any configuration and operation as long as the settings and operation described thus far can be implemented.

### (Host Management Unit 100)

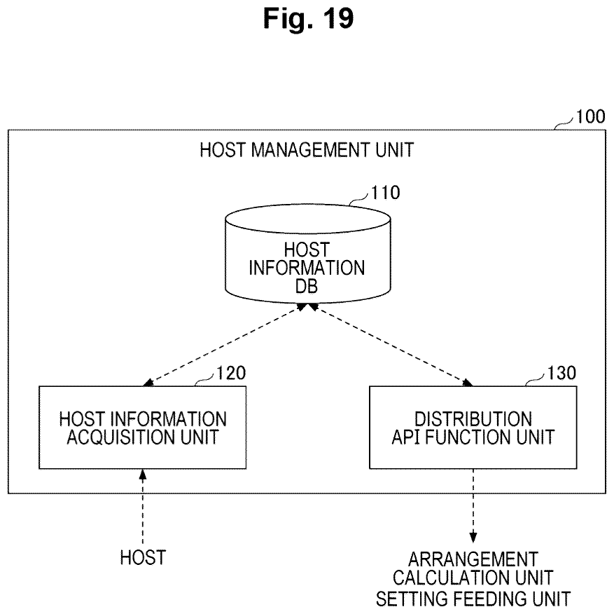

The host management unit 100 acquires the host name and the network information and resource information from each host and manages the acquired host name and network information and resource information in the DB. FIG. 19 illustrates a configuration of the host management unit 100. As illustrated in FIG. 19, the host management unit 100 includes a host information DB 110, a host information acquisition unit 120, and a distribution application programming interface (API) function unit 130.

The host information acquisition unit 120 accesses the host to acquire the above-mentioned information and stores the acquired information in the host information DB 110. The host information DB 110 manages the ID and the network information such as the IP address and the mac address of the host, and host resources.

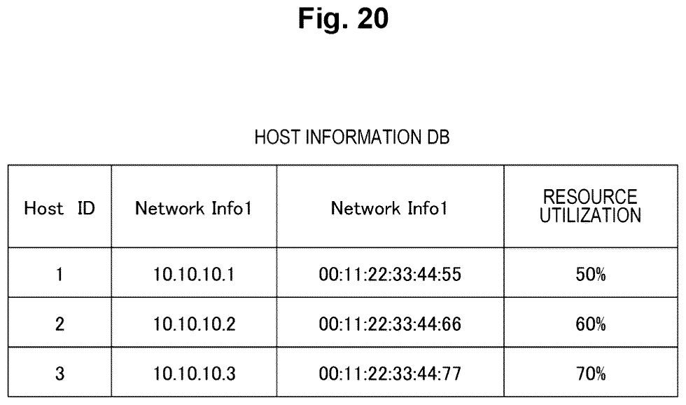

The external arrangement calculation unit 300 and setting feeding unit 400 access the host information DB 110 via the distribution API function unit 130 and acquire information necessary for processing, such as the network information and resource utilization. FIG. 20 illustrates an example of information stored in the host information DB 110.

### (Instance Management Unit 200)

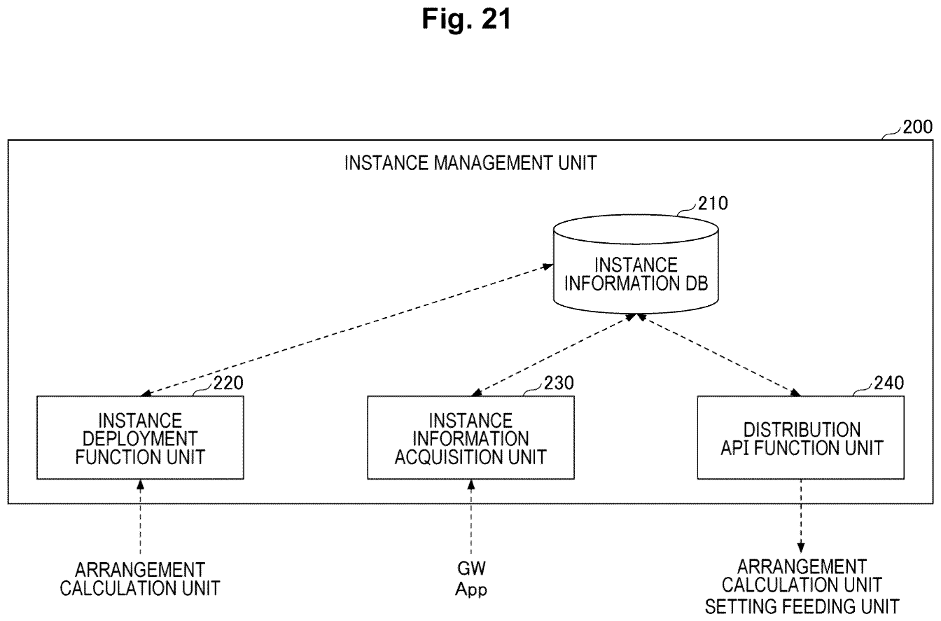

The instance management unit 200 deploys the instance. In addition, the instance name, the instance type, and the network information are acquired and managed by the DB. FIG. 21 illustrates a configuration example of the instance management unit 200.

As illustrated in FIG. 21, the instance management unit 200 includes an instance information DB 210, an instance deployment function unit 220, an instance information acquisition unit 230, and a distribution API function unit 240.

The instance deployment function unit 220 selects a host to deploy an instance on the basis of an instruction from the arrangement calculation unit 300.

The instance information acquisition unit 230 accesses the instance and acquires the above-mentioned information to store the acquired information in the instance information DB 210. The instance information DB 210 manages the ID and the network information such as the IP address and the mac address of the instance, and host resources.

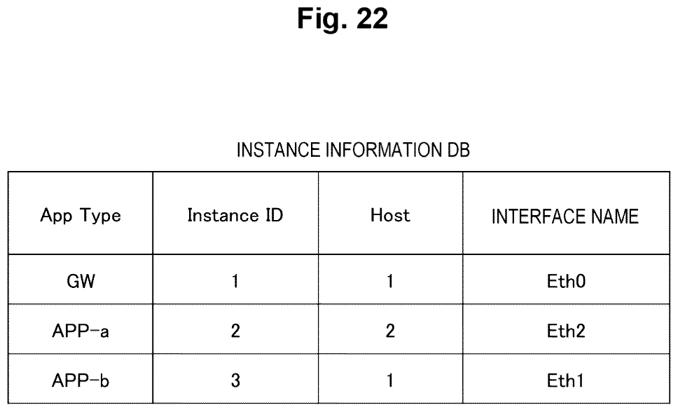

The external arrangement calculation unit 300 and setting feeding unit 400 access the instance information DB 210 via the distribution API function unit 240 and acquire necessary information such as the application type, the network information, and operating host information. FIG. 22 illustrates an example of information stored in the instance information DB 210.

### (Arrangement Calculation Unit 300)

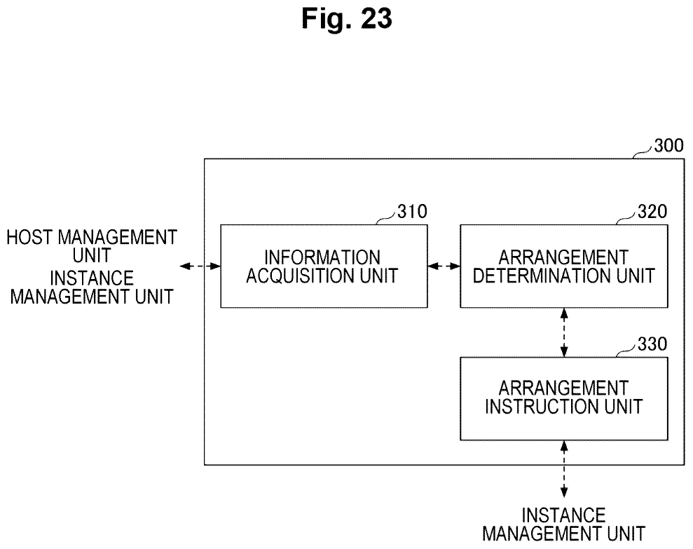

The arrangement calculation unit 300 determines a host to deploy an instance. FIG. 23 illustrates a configuration example of the arrangement calculation unit 300. As illustrated in FIG. 23, the arrangement calculation unit 300 includes an information acquisition unit 310, an arrangement determination unit 320, and an arrangement instruction unit 330.

The information acquisition unit 310 accesses the instance management unit 200 or the host management unit 100 via the distribution API function unit and acquires the resource availability for each host and the number of GW instances and APP instances already operating.

The arrangement determination unit 320 determines a host on which the GW instance is to be arranged, in line with the flow of the GW arrangement determination process (FIG. 16). In addition, as for the APP instance, a host on which the APP instance is to be arranged is determined such that the number of instances for each type of APP is made as equal as possible in units of hosts as long as the host resources permit.

The arrangement instruction unit 330 instructs the instance management unit 200 on the arrangement method on the basis of the calculation result of the arrangement determination unit 320.

### (Setting Feeding Unit 400)

The setting feeding unit 400 sets connmark and PBR necessary for the technique according to the present embodiment, for the host.

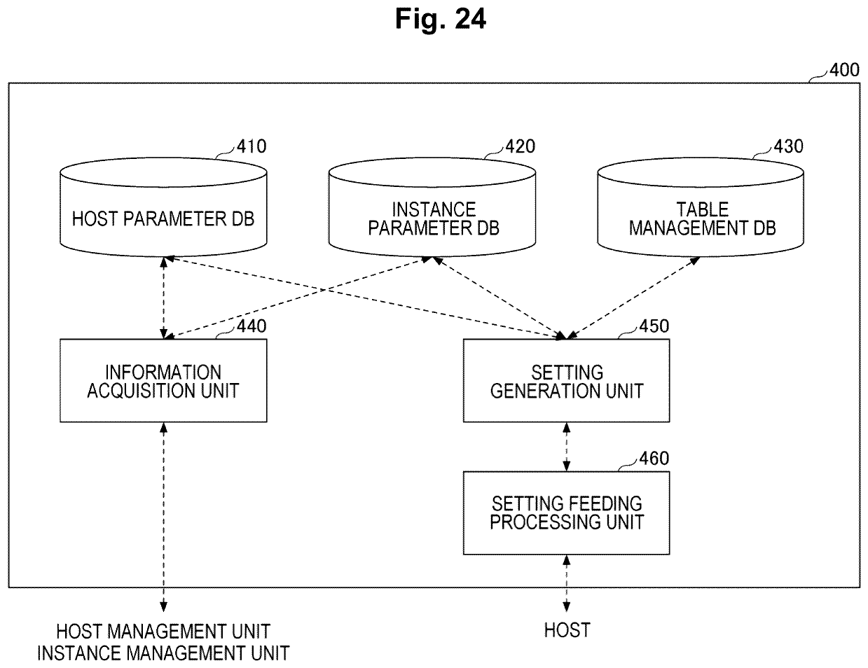

FIG. 24 illustrates a configuration example of the setting feeding unit 400. As illustrated in FIG. 24, the setting feeding unit 400 includes a host parameter DB 410, an instance parameter DB 420, a table management DB 430, an information acquisition unit 440, a setting generation unit 450, and a setting feeding processing unit 460.

The information acquisition unit 440 accesses the instance management unit 200 or the host management unit 100 via the distribution API function unit and acquires the resource availability for each host, the number of operating GW instances and APP instances, and the network information necessary for setting to store the acquired information in the corresponding DBs.

The instance parameter DB 420 manages the operation status and interface name of the instance. The host parameter DB 410 manages operation information and address information on the instance in the host. The table management DB 430 manages in which host the table for PBR is operating.

The setting generation unit 450 verifies the state of the number of instances for each host on the basis of information from various DBs and generates settings for connmark and PBR.

Examples of the settings include (1) connmark based on the interface name of the GW, (2) connmark based on the mac address of the host, and (3) setting for performing policy-based routing based on various mark values.

The setting feeding processing unit 460 makes settings for the relevant host on the basis of the calculation result of the setting generation unit 450.

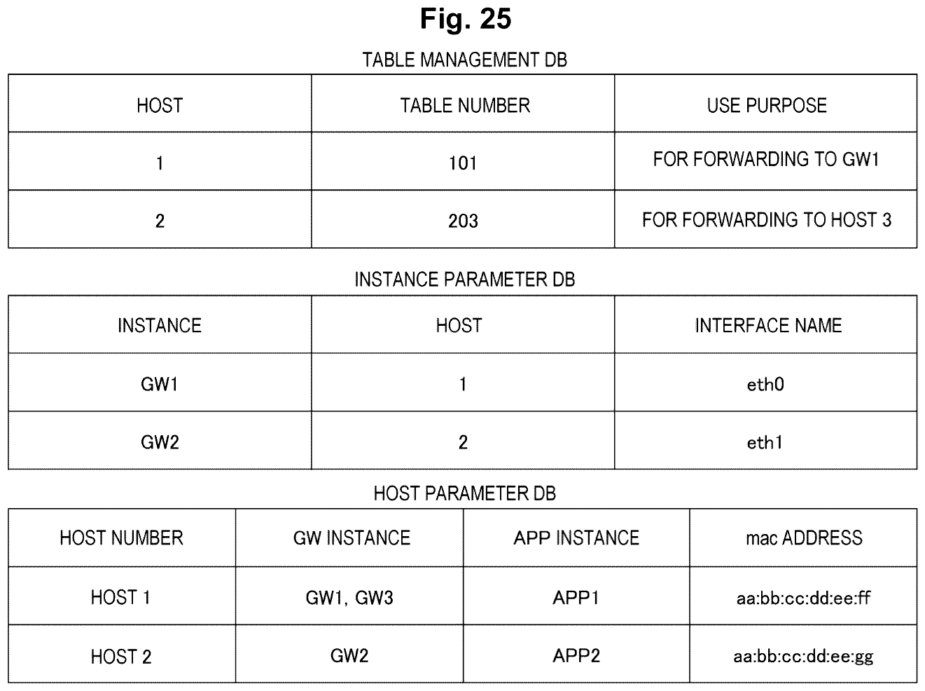

FIG. 25 illustrates an example of information to be stored, for each of the table management DB 430, the instance parameter DB 420, and the host parameter DB 410.

### Sequence Example 1

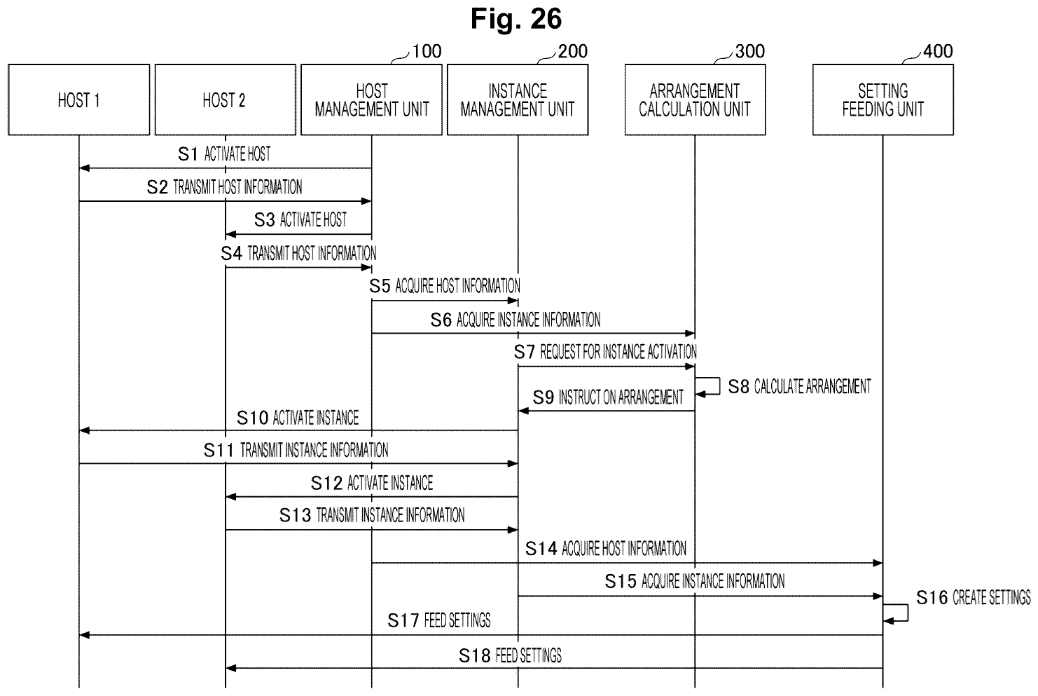

FIG. 26 illustrates a sequence example in a case where the instances are arranged in the hosts 1 and 2 as the arrangement of the instances at the time of starting the service. Each of the hosts 1 and 2 may be a physical machine or may be a virtual machine. The sequence illustrated in FIG. 26 illustrates a procedure of activating the host at the time of starting the service, calculating the arrangement of the instances, activating the instances, and feeding the settings to the hosts.

First, in S1 to S4, the host management unit 100 activates each host as an infrastructure constituting the service and collects information on each activated host. The collected information is stored in the host information DB 110 as illustrated in FIG. 20, for example.

In S5, the instance management unit 200 acquires host information from the host management unit 100. In S6, the arrangement calculation unit 300 acquires instance information from the host management unit 100.

In S7, the instance management unit 200 requests the arrangement calculation unit 300 to calculate the arrangement of the instances. In S8, the arrangement calculation unit 300 determines the arrangement on the basis of the information on the instances and the hosts and, in S9, instructs the instance management unit 200 to perform the arrangement.

On the basis of this instruction, in S10 to S13, the instance management unit 200 selects a host to activate an instance. With the activation, the instance information is transmitted to the instance management unit 200 and stored in the instance information DB (FIG. 22).

The setting feeding unit 400 acquires the host information from the host management unit 100 in S14 and acquires the instance information from the instance management unit 200 in S15. In S16, the setting feeding unit 400 creates necessary network settings such as connmark and PBR, using the acquired information, and feeds the settings to each host in S17 and S18.

### Sequence Example 2

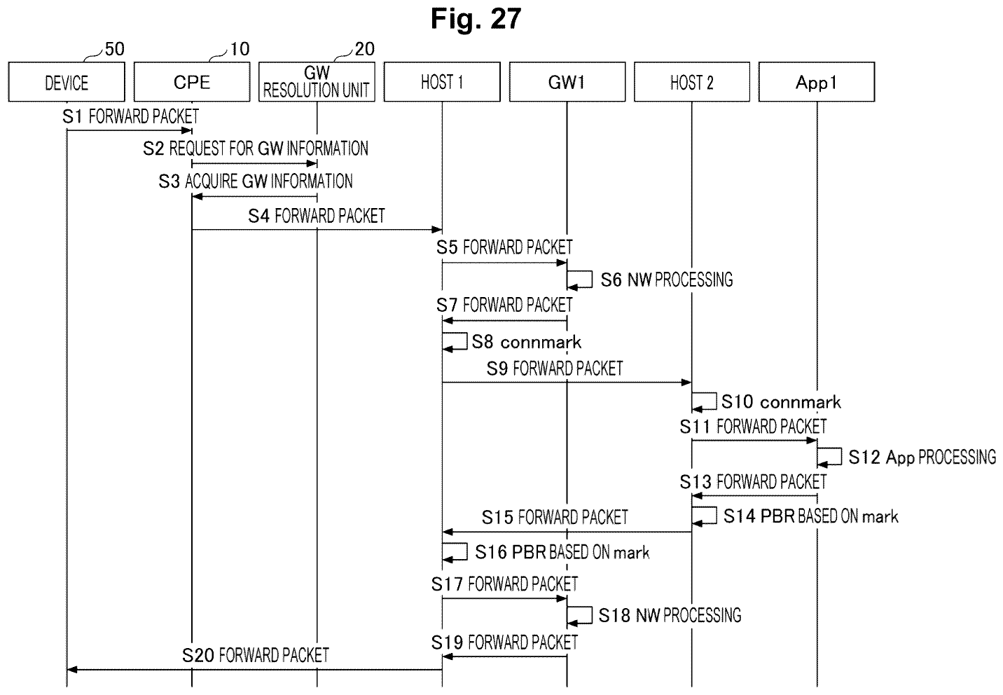

Next, as a packet forwarding procedure assumed in the present embodiment, a forwarding procedure in a case where the GW 1 is arranged in the host 1 and the App 1 is arranged in the host 2 will be described with reference to FIG. 27.

The packet transmitted by a device 50 arrives at the CPE 10 (S1) and, after the connection destination GW is resolved by an inquiry to the GW resolution unit 20 (S2, S3), is forwarded to the host 1 on which the GW 1 operates (S4).

The host 1 forwards the inflow packet to the GW 1 (S5). After the GW 1 treats this packet with its necessary NW processing in S6, the packet is forwarded again to the host 1 to communicate with the App 1 in S7.

In S8, the host 1 performs connmark with the interface name or the like corresponding to the GW 1. In S9, the host 1 transmits the packet marked for flow identification to the host 2 in order to communicate with the App 1.

In S10, the host 2 performs connmark on the packet with the source mac address (here, the address of the host 1) as a key. In S11 to S13, App processing for the packet is performed in the App 1.

In S14, the host 2 makes the mark value added in S10 correspond to the mac address, thereby performing PBR on the backward packet processed in the App 1 on the basis of the mark. This ensures that the packet is forwarded to the host 1 (S15). Similarly, in S16, the host 1 that has received the backward packet performs PBR for returning the packet to the inflow source GW 1 in accordance with the mark value associated with the interface name of the GW 1. NW processing is performed in S17 to S19, and the packet is forwarded to the device 50 from the host 1 in S20.

### Hardware Configuration Example

The GW resolution unit 20, the host management unit 100, the instance management unit 200, the arrangement calculation unit 300, the setting feeding unit 400, the GW resolution apparatus 20, the host management apparatus 100, the instance management apparatus 200, the arrangement calculation apparatus 300, the setting feeding apparatus 400, the hosts, the GWs, and the Apps can all be implemented by causing a computer to execute a program, for example. This computer may be a physical computer or may be a virtual machine on a cloud. Hereinafter, the GW resolution unit 20, the host management unit 100, the instance management unit 200, the arrangement calculation unit 300, the setting feeding unit 400, the GW resolution apparatus 20, the host management apparatus 100, the instance management apparatus 200, the arrangement calculation apparatus 300, the setting feeding apparatus 400, the hosts, the GWs, and the Apps are collectively referred to as apparatuses.

In other words, the apparatuses can be implemented by executing a program corresponding to processing carried out by the apparatuses, using hardware resources built in the computer, such as a central processing unit (CPU) and a memory. The above program can be saved and distributed by being recorded on a computer-readable recording medium (portable memory or the like). The above program can also be provided through a network such as the Internet or an electronic mail.

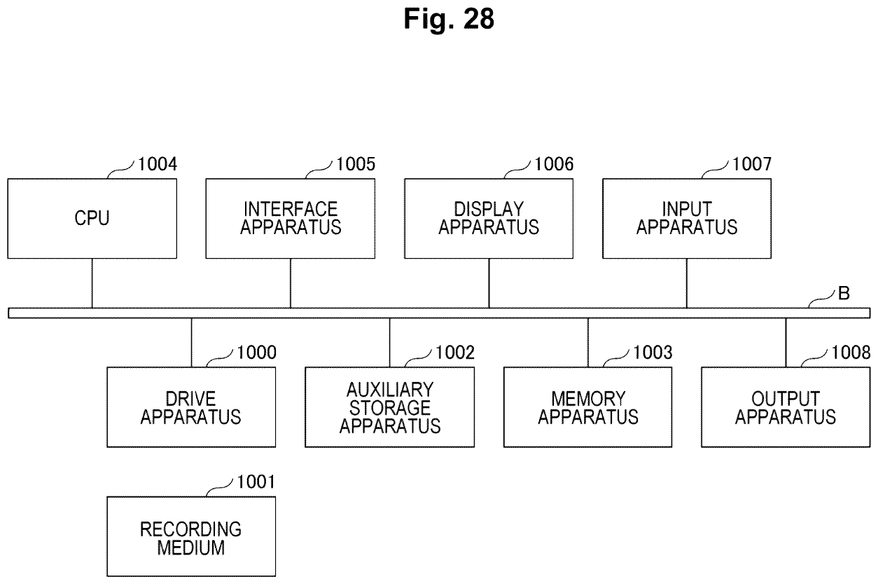

FIG. 28 is a diagram illustrating a hardware configuration example of the above computer. The computer in FIG. 28 includes a drive apparatus 1000, an auxiliary storage apparatus 1002, a memory apparatus 1003, a CPU 1004, an interface apparatus 1005, a display apparatus 1006, an input apparatus 1007, an output apparatus 1008, and the like, which are connected to one another by a bus BS.

A program for implementing processing in the computer is provided by a recording medium 1001 such as a compact disc read-only memory (CD-ROM) or a memory card, for example. When the recording medium 1001 storing the program is set in the drive apparatus 1000, the program is installed on the auxiliary storage apparatus 1002 from the recording medium 1001 through the drive apparatus 1000. Here, the program does not necessarily have to be installed from the recording medium 1001 and may be downloaded from another computer through a network. The auxiliary storage apparatus 1002 stores the installed program and also stores necessary files, data, and the like.

When an instruction to activate the program is given, the memory apparatus 1003 reads the program from the auxiliary storage apparatus 1002 and stores the program. The CPU 1004 implements a function related to the apparatuses in accordance with the program stored in the memory apparatus 1003. The interface apparatus 1005 is used as an interface for connection to a network or the like. The display apparatus 1006 displays a graphical user interface (GUI) or the like by the program. The input apparatus 1007 is constituted by a keyboard and a mouse, buttons, a touchscreen, or the like and is used to input a variety of operation instructions. The output apparatus 1008 outputs a computation result.

### Summary and Effects of Embodiments

As described above, in the present embodiment, in a service provided in a virtualization infrastructure environment to establish communication in a direction from a device to the service, the routing scheme of returning the backward packet in stages to the gateway instance or the host accommodating the gateway instance by policy-based routing based on connmark has been proposed.

More specifically, connmark with the interface corresponding to the GW as a key is performed in the host where the GW is operating, and connmark with the transmission source mac address as a key is performed in the host where the App is operating, whereby PBR addressed to the inflow source host corresponding to the mac address and PBR addressed to the inflow source GW corresponding to the interface are performed for the return communication.

In addition, the instance arrangement scheme that enables aggregation of settings necessary for implementing the above scheme has been proposed. Furthermore, a setting automation system that dynamically makes settings necessary for implementing the above scheme on the basis of an instance accommodation status in the host has been proposed.

With the present embodiment, in a technique for forwarding a packet processed by an application to an appropriate GW, it is ensured that a session is not to be disconnected even at the time of reconnection to the GW from a terminal and learning of a large number of routes is not required.

In addition, in the present technique, since rewriting of the packet header is unnecessary, application processing is not affected. It is also expected to reduce overheads without feeding settings into a large number of APP instances (endpoints).

### Supplements

Regarding the embodiment described above, the following supplements are further disclosed.

### Supplement 1

A communication system including:
a first host that includes a gateway configured to perform network processing on a packet transmitted from a device, attaches a first mark indicating that a forwarding source is the gateway to the packet forwarded from the gateway, and forwards the packet with the first mark attached; and
a second host that includes an application, receives the packet forwarded from the first host, marks the received packet with a second mark indicating that the forwarding source is the first host, forwards the packet with the second mark attached, to the application, and forwards the packet forwarded from the application to the first host on the basis of the second mark, in which
the first host forwards the packet received from the second host to the gateway on the basis of the first mark.

### Supplement 2

The communication system according to supplement 1, in which
the first host and the second host each use connmark to attach a mark to the packet and use policy-based routing to forward the packet on the basis of the mark.

### Supplement 3

An arrangement calculation apparatus for determining a host to which a gateway instance is to be deployed in a communication system including a plurality of hosts,
the arrangement calculation apparatus
including:
a memory; and
at least one processor connected to the memory; in which
the processor:
acquires resource information and the number of deployed gateway instances for each host; and
as long as the host has a resource for deploying the gateway instance, determines to deploy one gateway instance to each host, and determines to deploy the gateway instance that is not determined to be deployed, to the host in which the gateway instance has been deployed.

### Supplement 4

The arrangement calculation apparatus according to supplement 3, in which
the processor determines an arrangement of an application instance to each host such that the number of instances is made as equal as allowed between the hosts.

### Supplement 5

A setting feeding apparatus that feeds a setting to a host in a communication system including a plurality of hosts,
the setting feeding apparatus
including:
a memory; and
at least one processor connected to the memory; in which
the processor:
acquires host information and instance information in each host in which an instance is arranged;
generates, for the host in which a plurality of gateway instances is arranged, the setting for mark processing for an inflow flow for each gateway instance, and the setting for routing using a mark for a return flow for each gateway instance, and generates, for the host in which an application instance is arranged, the setting for the mark processing for the inflow flow, and the setting for the routing using the mark for the return flow; and
feeds the generated settings to a relevant host.

### Supplement 6

A communication method in a communication system including a first host including a gateway and a second host including an application,
the communication method including:
forwarding a packet transmitted from a device to the gateway, attaching a first mark indicating that a forwarding source is the gateway to the packet forwarded from the gateway, and forwarding the packet with the first mark attached, to the second host, by the first host; and
receiving the packet forwarded from the first host, marking the received packet with a second mark indicating that the forwarding source is the first host, forwarding the packet with the second mark attached, to the application, and forwarding the packet forwarded from the application to the first host on the basis of the second mark, by the second host, in which
the first host forwards the packet received from the second host to the gateway on the basis of the first mark.

### Supplement 7

A non-transitory storage medium storing a program for causing a computer to execute each process in the arrangement calculation apparatus according to supplement 3 or 4.

### Supplement 8

A non-transitory storage medium storing a program for causing a computer to execute each process in the setting feeding apparatus according to supplement 5.

As described above, the present embodiment has been described; however, the present invention is not limited to the described specific embodiment, and various modifications and changes can be made within the scope of the gist of the present invention described in claims.

### REFERENCE SIGNS LIST

10 CPE
20 GW resolution unit
30 DB
50 Device
100 Host management unit
110 Host information DB
120 Host information acquisition unit
130 Distribution API function unit
200 Instance management unit
210 Instance information DB
220 Instance deployment function unit
230 Instance information acquisition unit
240 Distribution API function unit
300 Arrangement calculation unit
310 Information acquisition unit
320 Arrangement determination unit
330 Arrangement instruction unit
400 Setting feeding unit
410 Host parameter DB
420 Instance parameter DB
430 Table management DB
440 Information acquisition unit
450 Setting generation unit
460 Setting feeding processing unit
1000 Drive apparatus
1001 Recording medium
1002 Auxiliary storage apparatus
1003 Memory apparatus
1004 CPU
1005 Interface apparatus
1006 Display apparatus
1007 Input apparatus
1008 Output apparatus

1. A communication system comprising:
a first host that includes a gateway configured to perform network processing on a packet that is transmitted from a device, the first host including first circuitry configured to
attach a first mark indicating that a source is the gateway, to the packet that is forwarded from the gateway, and
forward the packet to which the first mark is attached; and
a second host that includes an application and second circuitry, the second circuitry being configured to
receive the packet forwarded from the first host,
mark the received packet with a second mark indicating that a source is the first host,
forward the received packet to which the second mark is attached, to the application, and
forward the packet that is forwarded from the application to the first host based on the second mark, wherein
the first circuitry of the first host is configured to forward the packet received from the second host to the gateway based on the first mark.

2. The communication system according to claim 1, wherein
each of the first host and the second host is configured to use connmark to attach a corresponding mark among the first mark and the second mark to the packet, and use policy-based routing to forward the packet based on the corresponding mark.

3. A placement calculation apparatus for determining a host to which a gateway instance is to be deployed in a communication system including a plurality of hosts, comprising:
circuitry configured to
acquire resource information and the number of deployed gateway instances, for each host of the plurality of hosts; and
upon occurrence of a condition in which the host has a resource for deploying the gateway instance, determine to deploy one gateway instance to each host, and determine to deploy a given gateway instance that is undetermined to be deployed, to the host in which the gateway instance has been deployed.

4. The placement calculation apparatus according to claim 3, wherein the circuitry is configured to determine an arrangement of an application instance to each host such that an equal number of instances is set in each host.

5. (canceled)

6. A communication method in a communication system including a first host including a gateway and a second host including an application, comprising:
forwarding, by the first host, a packet transmitted from a device to the gateway, attaching, by the first host, a first mark indicating that a source is the gateway to the packet forwarded from the gateway, and forwarding, by the first host, the packet to which the first mark is attached, to the second host, and
receiving, by the second host, the packet forwarded from the first host, marking, by the second host, the received packet with a second mark indicating that a source is the first host, forwarding, by the second host, the packet with the second mark attached, to the application, and forwarding, by the second host, the packet forwarded from the application to the first host based on the second mark,
wherein the communication method further includes forwarding, by the first host, the packet received from the second host to the gateway based on the first mark.

7. (canceled)

8. A non-transitory computer readable storage medium storing a program for causing a computer to execute the communication method of claim 6.
